(19) United States
(12) Patent Application Publication
(10) Pub. No.: US 2008/0143973 A1
(43) Pub. Date: Jun. 19, 2008

(54) Light source device of laser LED and projector having the same device

(76) Inventor: Jing Miau Wu, Taipei (TW)

Correspondence Address: Raymond Sun, 12420 Woodhall Way, Tustin, CA, 92782, US

(21) Appl. No.: 11/580,260

(22) Filed: Oct. 12, 2006

(51) Int. Cl. G03B 21/00

(52) U.S. Cl. 353/33; 348/771

(57) ABSTRACT

A mono-panel projector having a light source device of laser LED is provided with at least one laser LED light source, at least one light magnifying element, a cross type color filter, a light guiding element, a prism module, a digital micromirror device, and a projecting lens module. The laser LED light source generates three small-diameter laser beams of red, green, and blue primary colors all of which are magnified by the light magnifying element, and concentrated into a composite laser beam by the cross type color filter. After that, the composite laser beam is guided by the light guiding element, and projected to the digital micromirror device via the prism module for generating images on the digital micromirror device. Then, the images are reflected to the projecting lens module followed by projecting out of the projecting lens module so that the projector of the present invention provides higher resolution, higher sharpness, brighter images, and higher color saturation by the laser LED light source while providing advantages of minimizing volume, lowering power consumption, enhancing reaction speed, elongating life time, and increasing power efficiency.

### BACKGROUND OF INVENTION

1. Field of the Invention

The present invention relates to a light source device of laser LED and a mono-panel projector having a light source device, and more particularly to a light source device using at least one laser LED light source for generating laser beam which is passed through and magnified to a predetermined extent by at least one light magnifying element while the light source device is applied to a mono-panel projector.

2. Description of the Prior Art

Presently, daily life of humans is facing an information era accompanying with advances of electronic industries day by day, and various information electronic products and apparatuses are improved and developed while various electronic elements for being assembled in electronic products are also designed more compactly. One of the important issues in consumer markets is how to design information electronic products more conveniently for human use, and easier to carry based on ergonomics and needs of consumers.

In the last ten years, optoelectronic industries have developed and advanced to provide many experiences and technologies of optoelectronic designs, optoelectronic simulations, optoelectronic processes, and optical spectrum tests, all of which are advantageous to further develop optoelectronic micro-products. The major trend of novel electronic products is to minimize volume and manufacturing cost thereof. Based on the advances of electronic hardware, computers, and microprocessors, various electronic products have improved very fast. Especially, optoelectronic micro-products will play an important role in the future. For example, manufacturers make efforts in how to minimize volume of optical projecting systems assembled in projectors for business use while increasing color saturation, illumination, and resolution thereof so as to design the projectors more compactly when notebook computers are more compact due to improvements of mobile technologies.

Generally, projectors are provided with light sources selected from one of tungsten halogen lamp, metal halide lamp, super high pressure mercury lamp, and xenon lamp (i.e. High Intensity Discharge lamp). However, except for respective disadvantages of these light sources as described above, these light sources have common disadvantages of generating high temperature, increasing power consumption, having shorter life time of lamps, increasing entire volume and weight, and decreasing portability. Thus, manufacturers try to improve traditional light emitting diodes (LEDs) which has advantage of lowering power consumption, reducing waste heat, minimizing volume, and elongating life time in order to use the traditional LEDs as light source devices of projectors. However, due to limits of optical properties of the traditional LEDs and scattered emitting mode thereof, the projectors using the traditional LEDs as light source devices only have relatively lower color saturation, brightness, and resolution of images while only providing lower light utilization efficiency. As a result, the projection brightness of the projectors can not be further enhanced due to the limitations as described above. Presently, the trend of consumers' needs is to pay more and more attention to image resolution of projectors, so manufacturers must make more effort on how to minimize volume of projectors while increasing image resolution, color saturation, light stability, and illumination thereof. It is therefore tried by the inventor to develop a light source device of laser LED and a projector having the light source device to solve the problems existing in the traditional projectors using the traditional LEDs.

### SUMMARY OF INVENTION

A primary object of the present invention is to provide a light source device of laser LED and a projector having a light source device, which is provided with at least one laser LED light source for generating at least one small-diameter laser beam which is passed through and magnified to a predetermined extent by at least one light magnifying element so as to constitute the light source device of the projector, wherein due to the small-diameter laser beam of the laser LED light source has optical properties of concentrating light and adjusting polarization phase of light, the laser LED light source of the projector can provide higher light resolution, sharpness, brightness, and saturation.

To achieve the above and other objects, the projector having the light source device of laser LED according to a preferred embodiment of the present invention comprises at least one laser LED light source, a cross type color filter, at least one light magnifying element, a light guiding element, a prism module, a digital micromirror device (DMD), and a projecting lens module. The laser LED light source generates three laser beams of red, green, and blue primary colors, all of which are concentrated into a composite laser beam by the cross type color filter. After that, the composite laser beam is passed through and magnified by the light magnifying element until a projecting area of the composite laser beam is preferably magnified in accordance with a magnifying transmission angle ranged from 30 to 60 degrees. Meanwhile, the magnified composite laser beam is guided by the light guiding element, and concentrated to a predetermined region followed by outputting the composite laser beam to the prism module in a uniformly concentrated manner. Then, the composite laser beam is projected to the digital micromirror device which has a plurality of micromirrors for digitally constituting images. Next, the images are projected out of the projector via the projecting lens module.

### BRIEF DESCRIPTION OF THE DRAWINGS

The details of the present invention will be more readily understood from a detailed description of the preferred embodiments taken in conjunction with the following figures.

FIG. 1 is a diagram of a light pathway of a projector having a light source device of laser LED according to a first preferred embodiment of the present invention;

FIGS. 2A and 2B are diagrams of a light magnifying element according to the first preferred embodiment of the present invention, which is used to magnify and diffuse a laser beam generated from a laser LED light source in accordance with two different preferred angles;

FIGS. 3A, 3B, 3C, and 3D are diagrams of various light magnifying elements according to the first preferred embodiment of the present invention;

FIG. 4 is a diagram of a light pathway of a projector having a light source device of laser LED according to a second preferred embodiment of the present invention; and

FIG. 5 is a diagram of a light pathway of a projector having a light source device of laser LED according to a third preferred embodiment of the present invention.

### DETAILED DESCRIPTION

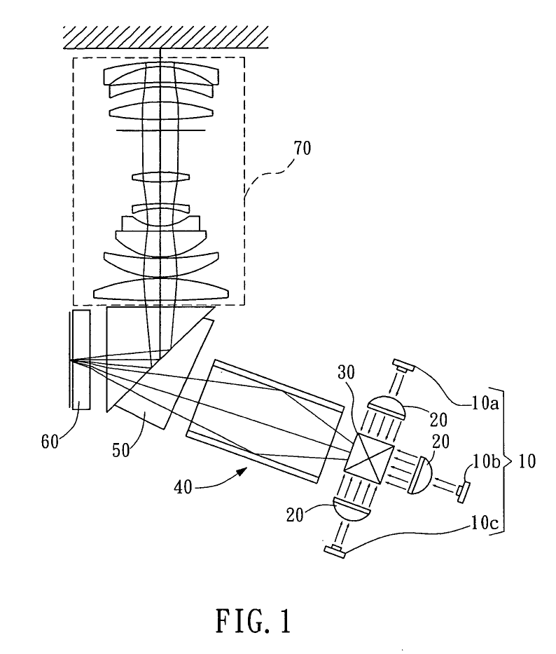

Referring now to FIG. 1, a light pathway of a projector having a light source device of laser LED according to a first preferred embodiment of the present invention is illustrated. As shown, the projector of the present invention is provided with at least one laser light emitting diode (also called LED hereinafter) light source designated by numeral 10, at least one light magnifying element designated by numeral 20, a cross type color filter designated by numeral 30, a light guiding element designated by numeral 40, a prism module designated by numeral 50, a digital micromirror device (i.e. DMD) designated by numeral 60, and a projecting lens module designated by numeral 70, all of which are suitably corresponding to each other.

Referring to FIG. 1, the laser LED light source 10 comprises three sets of laser LEDs 10a, 10b, and 10c for generating three different laser beams of red, green, and blue primary colors, respectively. Based on illuminating properties of the laser LEDs 10a, 10b, and 10c, the laser LEDs 10a, 10b, and 10c can be respectively used as a light source for generating a small-diameter laser beam which is parallel concentrated and can be used to adjust polarization phase of light for making the polarization phase accurate and reducing noise light.

Referring still to FIG. 1, the parallel small-diameter laser beams of red, green, and blue primary colors emitted by the laser LEDs 10a, 10b, and 10c are respectively magnified to a predetermined area range by the corresponding light magnifying elements 20, and then the magnified laser beams of red, green, and blue primary colors are guided into the cross type color filter 30. The cross type color filter 30 is provided with two polarizing lenses (unlabeled) which are vertical staggered with each other. The two polarizing lenses are used to concentrate the laser beams of red, green, and blue primary colors into a common composite laser beam having the same optical axis, and then the composite laser beam is projected into the light guiding element 40. Meanwhile, the composite laser beam is reflected within a predetermined range in the light guiding element 40 so that facula of the composite laser beam can be removed by the light guiding element 40, and the composite laser beam can be uniformly outputted and projected to the prism module 50. The prism module 50 is aligned with the light guiding element 40, and the composite laser beam uniformly outputted from the light guiding element 40 is projected into the digital micromirror device 60 via the prism module 50. The digital micromirror device 60 is an image generating unit which is positioned in a rear end of the prism module 50. The digital micromirror device 60 is a chipset provided with a plurality of micromirror lenses which are used to digitally constitute images from the composite laser beam uniformly outputted from the prism module 50. Then, the prism module 50 is further used to reflect the images generated from the digital micromirror device 60 into the projecting lens module 70 followed by projecting the images out of the projecting lens module 70.

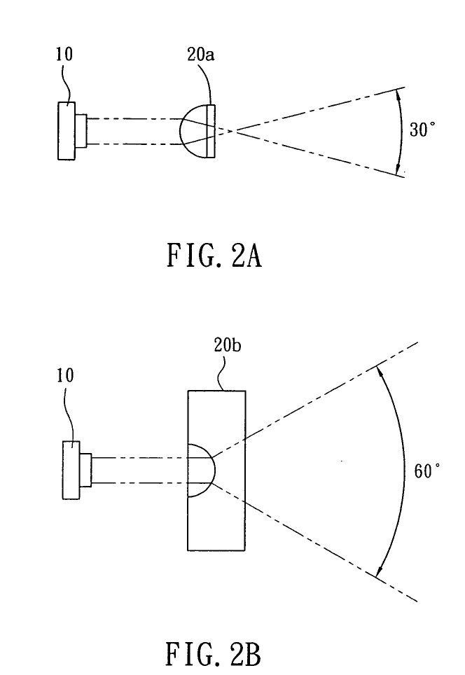

Referring back to FIGS. 2A and 2B, the light magnifying element 20 of the first preferred embodiment of the present invention is used to magnify and diffuse the laser beam generated from the laser LED light source 10 in accordance with two different preferred angles. The parallel small-diameter laser beam from the laser LED light source is selectively projected through the light magnifying element 20a or 20b until the laser beam is magnified to have a predetermined cross-sectional area range. In the present invention, the light magnifying element 20a or 20b can be selected from various lens structures made of glass, plastic, acrylic, or other equivalent transparent material. The light magnifying element 20a or 20b projects the laser beam in accordance with a magnifying transmission angle ranged from 30 degrees (as shown in FIG. 2A) to 60 degrees (as shown in FIG. 2B). Thus, the projected laser beam will be magnified to have a suitable cross-sectional area for further projecting on the digital micromirror device 60 while enhancing relative optical efficiencies such as illumination.

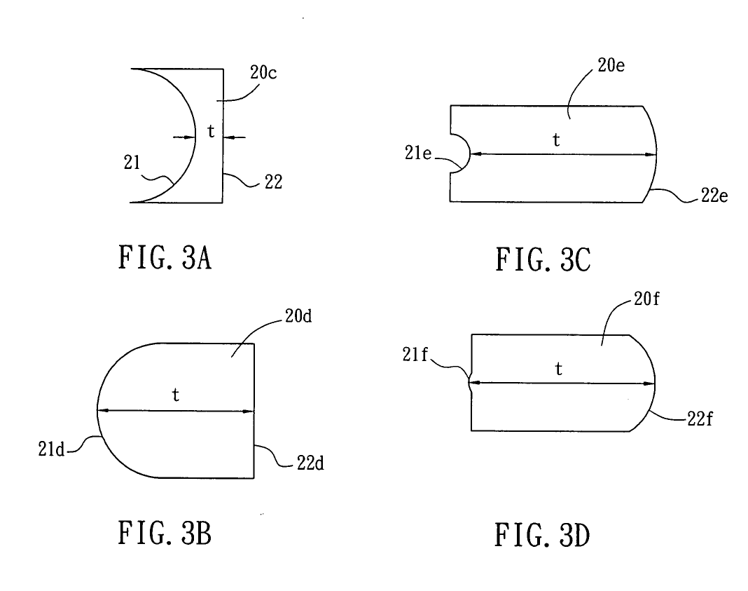

Referring back to FIGS. 3A, 3B, 3C and 3D, variations of the light magnifying elements 20 according to the first preferred embodiment of the present invention are illustrated. As shown in FIG. 3A, a light magnifying element 20c is selected from a concave lens made of glass of BK7 model (ND=1.516800; VD=64.17), and has an incident surface 21 as shown in a left side of FIG. 3A and an emitting surface 22 as shown in a right side of FIG. 3A. The incident surface 21 is a spherical concave surface which has a radius of about −1.4 mm (the negative number means that the spherical concave surface has a supposed circle center at a left side thereof). Furthermore, the emitting surface 22 is a planar surface which has a diameter of about 2.8 mm while the light magnifying elements 20c has a thickness “t” of about 0.6 mm. As shown in FIG. 3B, a light magnifying element 20d is selected from a convex lens made of glass, and has an incident surface 21d and an emitting surface 22d. The incident surface 21d is a spherical convex surface which has a diameter of about 2.8 mm (the positive number means that the spherical convex surface has a supposed circle center at a right side thereof). Furthermore, the emitting surface 22d is a planar surface which has a diameter of about 2.8 mm while the light magnifying elements 20c has a thickness “t” of about 3.4 mm. As shown in FIG. 3C, a light magnifying element 20e has an incident surface 21e and an emitting surface 22e. The incident surface 21e is a spherical concave surface which has a diameter of about −2 mm. Furthermore, the emitting surface 22e is a convex surface which has a radius about −9.05846 mm while the light magnifying elements 20e has a thickness “t” of about 20 mm. As shown in FIG. 3D, a light magnifying element 20f has an incident surface 21f and an emitting surface 22f. The incident surface 21f is a spherical convex surface which has a radius of about 1.5 mm. Furthermore, the emitting surface 22f is a convex surface which has a radius of about 10 mm while the light magnifying elements 20f has a thickness “t” of about 20 mm.

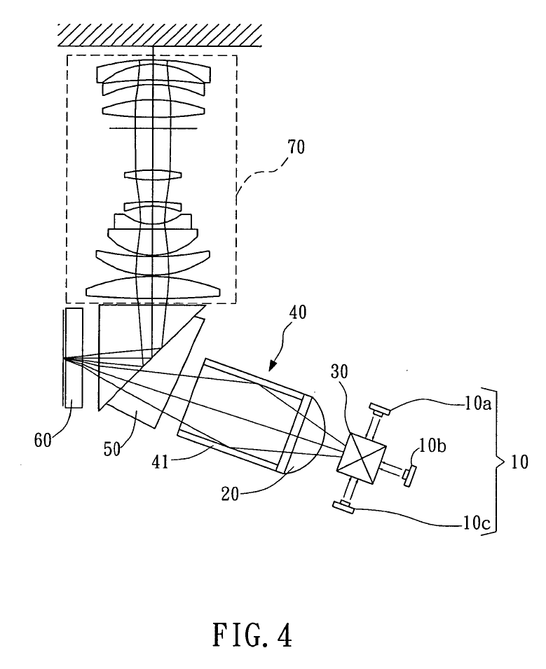

Referring now to FIG. 4, a light pathway of a projector having a light source device of laser LED according to a second preferred embodiment of the present invention is illustrated. Different from the first preferred embodiment in which the laser beams of red, green, and blue primary colors generated from the laser LED light sources 10a, 10b, and 10c are firstly projected to the corresponding light magnifying elements 20 for magnifying the laser beams, the laser beams of red, green, and blue primary colors generated from the laser LED light sources 10a, 10b, and 10c in the second preferred embodiment are firstly projected to the cross type color filter 30 so as to combine into a common composite laser beam having the same optical axis. Then, the composite laser beam is projected to the light magnifying elements 20 for magnifying the composite laser beams until the composite laser beam is magnified to have a predetermined cross-sectional area range. Next, the composite laser beam is projected into the light guiding element 40 positioned thereof. The light guiding element 40 is preferably selected from a light pipe 41 which is integrated into a unit with the light magnifying elements 20. The magnified composite laser beam is reflected within a predetermined range in the light pipe 41 (i.e. the light guiding element 40) so that facula of the composite laser beam can be removed by the light pipe 41, and the composite laser beam can be uniformly outputted and projected to the prism module 50. The composite laser beam uniformly outputted from the light guiding element 40 is projected into the digital micromirror device 60 via the prism module 50. The digital micromirror device 60 is used to digitally constitute images from the composite laser beam uniformly outputted from the prism module 50. Then, the prism module 50 is further used to reflect the images generated from the digital micromirror device 60 into the projecting lens module 70 followed by projecting the images out of the projecting lens module 70.

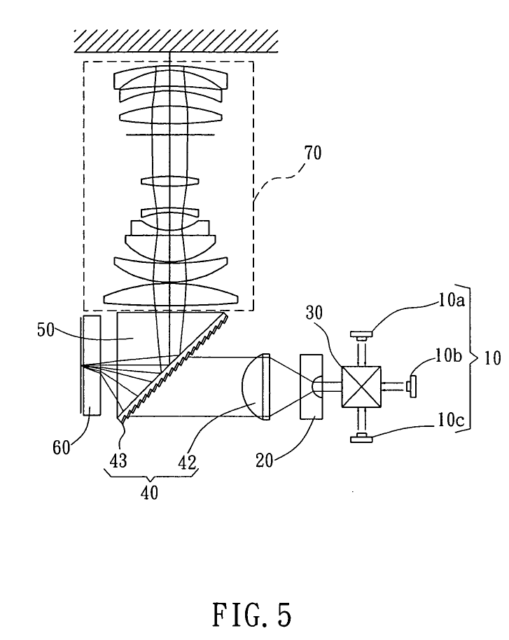

Referring now to FIG. 5, a light pathway of a projector having a light source device of laser LED according to a third preferred embodiment of the present invention is illustrated. The third preferred embodiment as shown in FIG. 5 is substantially similar to the second preferred embodiment as shown in FIG. 4 so that similar elements in the third preferred embodiment are designated by the same numerals in the second preferred embodiment, and the detailed descriptions thereof will be omitted hereinafter.

Referring to FIG. 5, the light guiding element 40 of the third preferred embodiment is further provided with a condensing lens 42 and a micromirror lens array (MLA) 43. The condensing lens 42 is a lens having a refractive index corresponding to (for ex., contrary to) that of the light magnifying element 20, and the condensing lens 42 is aligned with the light magnifying element 20 so that the condensing lens 42 can be used to condense the composite laser beam magnified by the light magnifying element 20 and then convert the magnified composite laser beam into a parallel magnified composite laser beam which will be further projected to the micromirror lens array 43. The micromirror lens array 43 is provided with a plurality of micromirror lenses for removing facula of the parallel magnified composite laser beam which will be uniformly outputted and projected to the prism module 50.

As described above, the projector having the light source device of laser LED according to the preferred embodiment of the present invention is provided with the laser LED light source 10 and the light magnifying element 20 to make the best of illuminating properties of the laser LEDs 10a, 10b, and 10c, i.e. optical properties for generating and concentrating a parallel small-diameter laser beam while adjusting polarization phase of light for making the polarization phase accurate and reducing noise light. Thus, the projector having the light source device of laser LED according to the preferred embodiment of the present invention provides higher resolution, brighter images, and higher color saturation in relation to traditional LED light source while providing advantages of minimizing volume, lowering power consumption, enhancing reaction speed, elongating life time, and increasing power efficiency.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A light source device of laser LED for a projector, comprising:
at least one laser LED light source for generating a parallel concentrated beam; and
at least one light magnifying element corresponding to the laser LED light source for magnifying the parallel concentrated beam generated from the laser LED light source in accordance with a predetermined angle.

2. The light source device of laser LED as claimed in claim 1, wherein said laser LED light source comprises three sets of laser LEDs for generating three parallel concentrated beams of red, green, and blue primary colors, respectively.

3. The light source device of laser LED as claimed in claim 1, wherein said light magnifying element is selected from a convex lens or a concave lens.

4. The light source device of laser LED as claimed in claim 1, wherein said light magnifying element is made of glass or transparent acrylic material.

5. The light source device of laser LED as claimed in claim 1, wherein said predetermined angle of the light magnifying element for magnifying the parallel concentrated beams is ranged from 30 degrees to 60 degrees.

6. The light source device of laser LED as claimed in claim 2, wherein said projector further comprises:
a cross type color filter corresponding to the laser LED light source for combining the three parallel concentrated beams of red, green, and blue primary colors generated from the three sets of laser LEDs into a composite beam having the same optical axis;
a light guiding element corresponding to the light magnifying element for guiding the magnified composite beam to reflect within a predetermined range in the light guiding element;
a prism module corresponding to the light guiding element for reflecting the composite beam projected from the light guiding element;
a digital micromirror device corresponding to the prism module for receiving the composite beam projected from the prism module to generate images which are reflected back to the prism module; and
a projecting lens module for projecting the images generated from the digital micromirror device and reflected through the prism module out of the projecting lens module.

7. The light source device of laser LED as claimed in claim 6, wherein said light guiding element is selected from a light pipe or a combination of a condensing lens and a micromirror lens array.

8. The light source device of laser LED as claimed in claim 7, wherein said micromirror lens array is provided with a plurality of micromirror lenses.

9. A projector having a light source device of laser LED, comprising:
at least one laser LED light source for generating a parallel concentrated beam;
at least one light magnifying element for magnifying the parallel concentrated beam generated from the laser LED light source in accordance with a predetermined angle;
a light guiding element corresponding to the light magnifying element for guiding the magnified composite beam to reflect within a predetermined range in the light guiding element;
a prism module corresponding to the light guiding element for reflecting the composite beam projected from the light guiding element;
a digital micromirror device corresponding to the prism module for receiving the composite beam projected from the prism module to generate images which are reflected back to the prism module; and
a projecting lens module for projecting the images generated from the digital micromirror device and reflected through the prism module out of the projecting lens module.

10. The projector as claimed in claim 9, wherein said light magnifying element is selected from a convex lens or a concave lens.

11. The projector as claimed in claim 9, wherein said light magnifying element is made of glass or transparent acrylic material.

12. The projector as claimed in claim 9, wherein said predetermined angle of the light magnifying element for magnifying the parallel concentrated beams is ranged from 30 degrees to 60 degrees.

13. The projector as claimed in claim 9, wherein said light guiding element is selected from a light pipe or a combination of a condensing lens and a micromirror lens array.

14. The projector as claimed in claim 13, wherein said micromirror lens array is provided with a plurality of micromirror lenses.

15. A light source device of laser LED for a projector, comprising:
at least one laser LED light source provided with three sets of laser LEDs for generating three parallel beams of red, green, and blue primary colors, respectively;
a cross type color filter corresponding to the three sets of laser LEDs for combining the three parallel beams of red, green, and blue primary colors generated from the three sets of laser LEDs into a parallel composite beam having the same optical axis; and
at least one light magnifying element corresponding to the cross type color filter for magnifying the parallel composite beam projected from the cross type color filter in accordance with a predetermined angle ranged from 30 degrees to 60 degrees.

16. The light source device of laser LED as claimed in claim 15, wherein said light magnifying element is selected from a convex lens or a concave lens.

17. The light source device of laser LED as claimed in claim 15, wherein said light magnifying element is made of glass or transparent acrylic material.
